(19) United States
(12) Patent Application Publication
(10) Pub. No.: US 2013/0249230 A1
(43) Pub. Date: Sep. 26, 2013

(54) TRIM PANELS FOR MOUNTING TO SUPPORT STRUCTURES OF AUTOMOTIVE VEHICLES BY RENTION CLIPS

(71) Applicants: Daniel F. Gillay, Plymouth, MI (US); Carl D. Spamer, Brighton, MI (US)

(72) Inventors: Daniel F. Gillay, Plymouth, MI (US); Carl D. Spamer, Brighton, MI (US)

(73) Assignee: Toyota Motor Engineering & Manufacturing North America, Inc., Erlanger, KY (US)

(21) Appl. No.: 13/427,377

(22) Filed: Mar. 22, 2012

(51) Int. Cl. B60R 13/02

(52) U.S. Cl. 296/1.08

(57) ABSTRACT

A trim panel for mounting to a support structure of a vehicle by a retention clip includes an inner surface facing an interior and an outer surface facing the support structure and a two-stage retention clip housing extending from the outer surface. The two-stage retention clip housing includes a top surface and at least one sidewall coupling the top surface to the trim panel such that the top surface is spaced apart from the outer surface. The top surface includes a first aperture defining a pre-installation clip position for receiving a head of the retention clip, a second aperture defining an installed clip position for receiving a head of the retention clip, a first channel extending from an edge of the top surface to the first aperture and a second channel extending from the first aperture to the second aperture.

### TECHNICAL FIELD

The present specification generally relates to trim panels for mounting to support structures of automotive vehicles utilizing a retention clip and, more specifically, to trim panels for mounting to support structures of automotive vehicles having housings which accommodate retention clips in a pre-installation clip position and a separate installed clip position.

### BACKGROUND

Many automobiles utilize trim panels to improve the appearance of the interior passenger compartment of the vehicle. The trim panels are attached to support structures of the vehicle using a plurality of retention clips located at various positions on the outer surface of the trim panel. The retention clips have a body portion for attaching to an opening in the support structure and a head portion for attaching to housings on the trim panel. Oftentimes, the retention clips are installed in the housings on the trim panels in advance of the installation of the trim panel to the support structure. To install the trim panel to the support structure, the body portions of the retention clips are inserted into mounting apertures located on the support structure. The easiest and most efficient way to insert the retention clips is in a direction normal to the support structure.

However, problems arise when trim panels are configured in such a manner that the retention clips are not installed normal to the mounting apertures. As an example of this, in some cases a bottom edge of the trim panel is first installed and held in a stationary position, and the top edge of the trim panel is then rotated into the installed position. In this instance, the retention clips are not installed normal to the mounting apertures. However, those retention clips closer to the top edge of the trim panel are oriented close enough to normal such that the body portion of the retention clip is still easily inserted into the mounting aperture. This is not the case for retention clips located nearer the bottom edge of the trim panel. In some cases, the body portions of the retention clips may be deformed during installation thereby damaging the clips or even causing a mis-installation of the trim panel with the support structure. Such mis-installations increase production losses and/or warranty costs thereby increasing vehicle production costs.

Accordingly, a need exists for alternative trim panels which facilitate mounting a trim panel to a support structure of an automotive vehicle with a retention clip that cannot be installed substantially normal the support structure.

### SUMMARY

In one embodiment, a trim panel for mounting to a support structure of an automotive vehicle by a retention clip may include an inner surface facing an interior of the vehicle and an outer surface facing the support structure, and a two-stage retention clip housing extending from the outer surface. The two-stage retention clip housing may include a top surface and at least one sidewall coupling the top surface of the two-stage retention clip housing to the outer surface of the trim panel such that the top surface is spaced apart from the outer surface. The top surface may include a first aperture defining a pre-installation clip position for receiving a head of the retention clip, a second aperture defining an installed clip position for receiving a head of the retention clip, a first channel extending from an edge of the top surface to the first aperture, and a second channel extending from the first aperture to the second aperture. Furthermore, the first channel extends through the edge of the top surface and opens into the first aperture; and the second channel opens into the first aperture and the second aperture.

In another embodiment, a trim panel assembly for mounting to a support structure of an automotive vehicle may include: a retention clip having a body portion and a head portion, the head portion having a head flange spaced apart from a body flange; a trim panel including an inner surface facing an interior of the vehicle and an outer surface facing the support structure; and a two-stage retention clip housing extending from the outer surface. The two-stage retention clip housing may include a top surface and at least one sidewall coupling the top surface of the two-stage retention clip housing to the outer surface of the trim panel such that the top surface is spaced apart from the outer surface. The top surface may include a first aperture, the first aperture defining a pre-installation clip position, a second aperture extending through the thickness of the top surface, the second aperture defining an installed clip position, a first channel extending from an edge of the top surface to the first aperture, wherein the first channel opens into the first aperture, and a second channel extending from the first aperture to the second aperture, wherein the second channel opens into the first aperture and the second aperture. Furthermore, the head portion of the retention clip is slidably engaged with the two-stage retention clip housing in the pre-installation clip position such that the retention clip is slidable from the pre-installation clip position to the installed clip position through the second channel upon attachment of the trim panel assembly to the support structure.

In yet another embodiment, a trim panel assembly for mounting to a support structure of an automotive vehicle may include a retention clip having a body portion and ahead portion, a trim panel having an inner surface facing an interior of the vehicle and an outer surface facing the support structure, and a two-stage retention clip housing extending from the outer surface of the trim panel. The two-stage retention clip housing may include a top surface with a pre-installation clip position, an installed clip position, and a channel extending between the pre-installation clip position and the installed clip position. The head portion of the retention clip is slidably engaged with the two-stage retention clip housing in the pre-installation clip position such that the retention clip is slidable from the pre-installation clip position to the installed clip position through the second channel upon attachment of the trim panel assembly to the support structure.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts the outside surface of a trim panel according to one or more embodiments shown and described herein;

FIG. 2 schematically depicts the inside surface of a trim panel according to one or more embodiments shown and described herein;

FIG. 3 schematically depicts a two-stage retention clip housing for receiving a retention clip according to one or more embodiments shown and described herein;

FIG. 4 schematically depicts a cross section of a retention clip for securing a trim panel to an attachment structure according to one or more embodiments shown and described herein;

FIG. 5 schematically depicts the retention clip of FIG. 4 positioned in a pre-installation clip position of the two-stage retention clip housing of FIG. 3;

FIG. 6A schematically depicts a trim panel positioned for installation on a support structure of a vehicle according to one or more embodiments shown and described herein;

FIG. 6B schematically depicts a trim panel installed on a support structure of a vehicle according to one or more embodiments shown and described herein;

FIG. 7A schematically depicts a retention clip in the pre-installation position of a two-stage retention clip housing prior to engagement with a mounting aperture of a support structure of a vehicle; and

FIG. 7B schematically depicts a retention clip in the installed position of a two-stage retention clip housing after engagement with a mounting aperture of a support structure of a vehicle.

### DETAILED DESCRIPTION

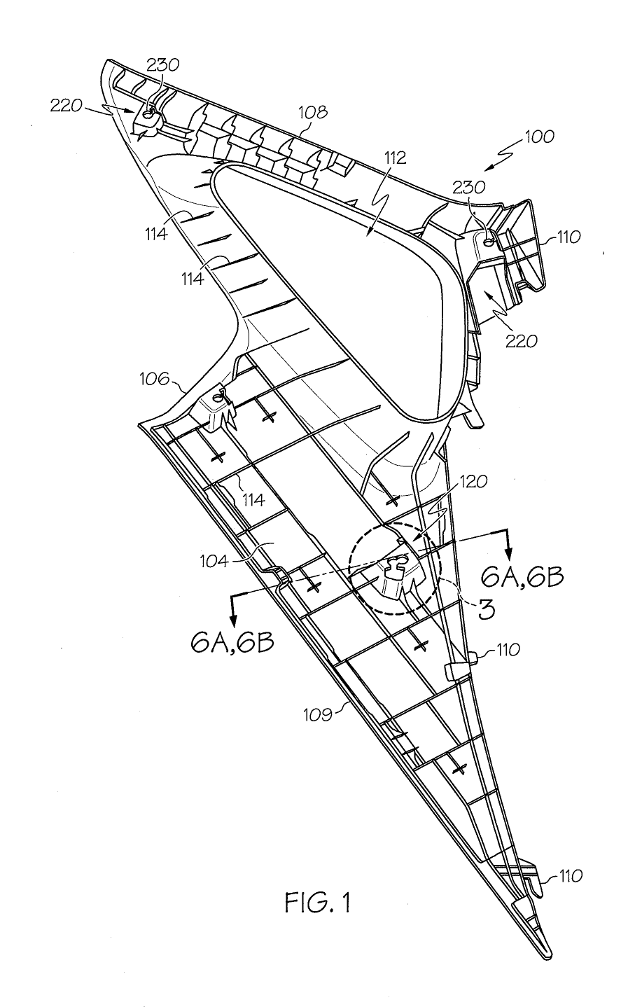

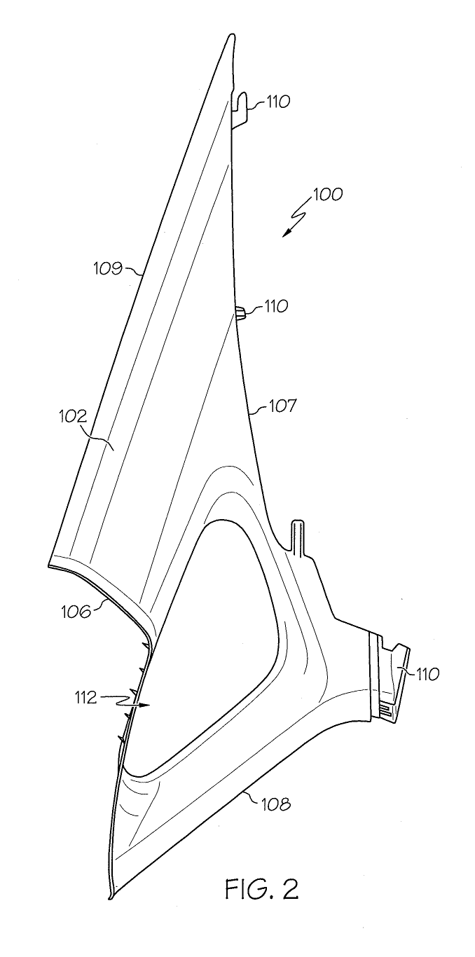

FIGS. 1 and 2 generally depict a trim panel for mounting to a support structure of an automotive vehicle using retention clips. The trim panel generally includes an inner surface facing an interior of the vehicle, an outer surface facing the support structure, and at least one two-stage retention clip housing for receiving a retention clip extending from the outer surface. The at least one two-stage retention clip housing includes a top surface and at least one sidewall coupling the top surface of the two-stage retention clip housing to the outer surface of the trim panel such that the top surface is spaced apart from the outer surface. The top surface of the at least one two-stage retention clip housing includes a first aperture defining a pre-installation clip position for receiving a head of a retention clip, a second aperture defining an installed clip position for receiving a head of the retention clip, a first channel extending from an edge of the top surface to the first aperture, and a second channel extending from the first aperture to the second aperture. Various embodiments of trim panels will be described in more detail herein with specific reference to the appended drawings.

Referring now to FIGS. 1 and 2, the inner surface 102 and outer surface 104 of a trim panel 100 are schematically depicted. In at least one embodiment, the trim panel 100 is a garnish for a C-pillar of an automotive vehicle. However, it should be understood that alternative embodiments of the trim panel may take the form of A-pillar garnishes, B-pillar garnishes, or any other trim panel for attachment to the interior or exterior of an automotive vehicle.

In the embodiments described herein, the trim panel 100 is formed from moldable polymeric material. Non-limiting examples of such materials include various types of structural plastics such as engineered polymeric materials of which polypropylene is but one example. Other suitable materials include, without limitation, thermoplastic olefin, acrylonitrile butadiene styrene, styrene maleic anhydride, polycarbonate/acrylonitrile butadiene styrene alloy, or other materials suitable for molding a rigid structure. In some embodiments, the trim panel 100 may also include a cover layer formed from vinyl, thermoplastic elastomer, PVC, or other suitable materials for molding flexible cover layers. Alternatively, cover layers may be formed form fabric or leather.

The trim panel 100 may be formed by an injection molding process. Other suitable methods may be used for forming the trim panel 100, including, without limitation, industrial blow molding, reaction injection molding, rotational molding, thermoforming, thermoplastic compression molding, and twin-sheet forming.

The trim panel 100 may have a unitary body structure that includes an inner surface 102 and an outer surface 104. The trim panel 100 is at least partially defined by an upper edge 106, a lower edge 107, a leading side edge 108, and a trailing side edge 109. The trim panel 100 may also include one or more openings 112 in the body for windows and the like. The trim panel 100 is configured such that the upper edge 106 can be positioned proximate the roof of the vehicle when the trim panel 100 is installed in the vehicle. The leading side edge 108 may be positioned proximate the passenger compartment when the trim panel 100 is in the installed condition. The trailing side edge 109 may be positioned aft of the passenger compartment when the trim panel 100 is in the installed position. In the embodiment of the trim panel 100 depicted in FIGS. 1 and 2, the lower edge 107 includes one or more protruding attachment guides 110. The attachment guides 110 are sized and shaped to penetrate and be retained in openings, such as slotted openings, formed in the support structure to which the trim panel is attached.

Referring to FIG. 2, the trim panel 100 includes an inner surface 102 exposed to the passenger compartment of the vehicle. The inner surface 102 typically includes a decorative or aesthetically appealing design. For example, in some embodiments, the inner surface 102 may be formed with a variety of colors and/or patterns. In other embodiments, the entire trim panel may be formed from a single color. In some embodiments of the trim panels described herein, an additional cover layer of material, such as a decorative fabric or a similar sheet material, may be molded or otherwise secured to the inner surface 102. In other embodiments, the inner surface 102 of the trim panel may have a smooth surface or a textured surface.

Referring to FIG. 1, the trim panel 100 also includes an outer surface 104 opposite the inner surface 102. The outer surface 104 faces the support structure 170 of the vehicle to which the trim panel is attached. The outer surface 104 includes at least one two-stage retention clip housing 120 integrally formed with the outer surface 104 of the trim panel 100. The outer surface 104 may also include reinforcement members 114, for example, without limitation, connection reinforcement projections integrally molded to the outer surface 104. As depicted in FIG. 1, the outer surface 104 includes a plurality of reinforcement projections configured as a series of ribs positioned at a spaced distance along at least a portion of the outer surface 104 of the trim panel 100. In this embodiment, the reinforcement projections are integrally molded to the outer surface 104. Alternatively, the reinforcement projections may be separately formed and attached to the outer surface 104.

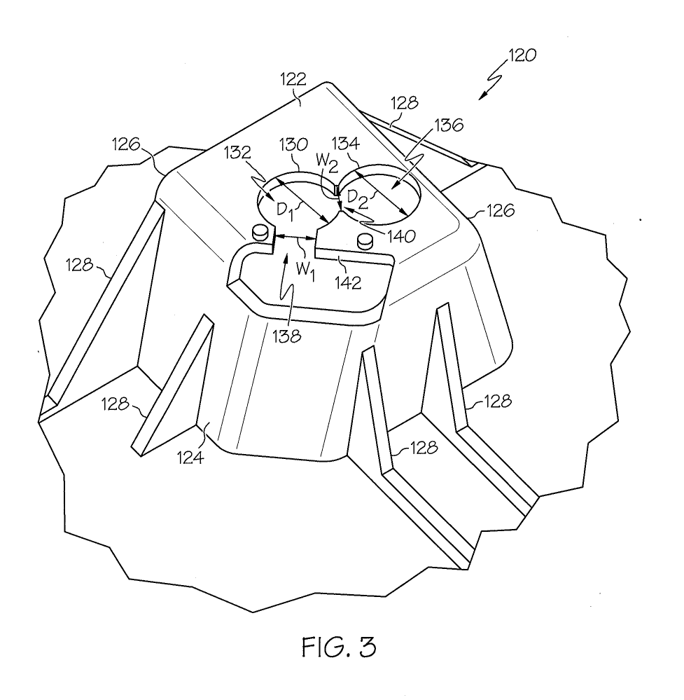

Referring now to FIGS. 1 and 3, one embodiment of a two-stage retention clip housing 120 is schematically depicted. The two-stage retention clip housing projects from the outer surface 104 of the trim panel 100 toward the support structure to which the trim panel is attached. The two-stage retention clip housing 120 generally includes at least one sidewall which couples the housing to the instrument panel. For example, in one embodiment, the two-stage retention clip housing 120 includes a top surface 122, a first sidewall 124, and a second sidewall 126. The first sidewall 124 and second sidewall 126 couple the top surface 122 of the two-stage retention clip housing 120 to the outer surface 104 of the trim panel 100 such that the top surface 122 is spaced apart from the outer surface 104. In some embodiments, the two-stage retention clip housing 120 may also include a plurality of support ribs 128 to increase the structural strength and stability of the two-stage retention clip housing 120 as depicted in FIGS. 1 and 3.

Still referring to FIGS. 1 and 3, the top surface 122 of the two-stage retention clip housing 120 includes a first aperture 130, a second aperture 134, a first channel 138, and a second channel 140. While the first aperture 130 and the second aperture 134 are depicted as circular in FIGS. 1, 3 and 4, it should be understood that apertures of other geometrical cross sections are also contemplated including, without limitation, ovals, squares, irregular geometric shapes and the like. The first aperture 130 generally defines a pre-installation clip position 132 for receiving a head portion 152 of a retention clip 150. The second aperture 134 generally defines an installed clip position 136 for receiving a head portion 152 of a retention clip 150. The first aperture 130 generally has a diameter D1 and the second aperture 134 has a diameter D2. In the embodiments of the two-stage retention clip housing 120 depicted in FIG. 3, the diameter D1 and the diameter D2 are the same. However, in alternative embodiments (not shown) the diameter D1 and the diameter D2 may be different. For example, in some embodiments, the diameter D1 may be larger than the diameter D2. In this embodiment, the larger diameter D1 of the first aperture 130 may facilitate quickly and easily positioning a retention clip in the pre-installation clip position 132 while the smaller diameter D of the second aperture 134 may firmly secure the retention clip 150 in the installed clip position 136 by forming a tight interference fit between the retention clip 150 and the second aperture 134.

Still referring to FIG. 3, the first channel 138 generally has a width W1 and extends from an edge 142 of the top surface 122 to the first aperture 130. The first channel 138 extends through the edge 142 of the top surface 122 and opens into the first aperture 130. Forming the first channel 138 such that it extends through the edge 142 of the top surface 122 and opens into the first aperture 130 facilitates the installation of a retention clip (not shown) through the first channel 138 and into the pre-installation clip position 132 defined by the first aperture 130.

The second channel 140 generally has a width W2 and extends from the first aperture 130 to the second aperture 134. The second channel 140 may also open into the first aperture 130 and the second aperture 134. Forming the second channel 140 such that the second channel 140 opens into both the first aperture 130 and the second aperture 134 facilitates sliding a retention clip through the second channel 140 from the pre-installation clip position 132 of defined by the first aperture 130 to the installed clip position 136 defined by the second aperture 134.

In the embodiments described herein, the width W1 of the first channel 138 and the width W2 of the second channel 140 are substantially equal. However, in some other embodiments, the widths W1, W2 need not be equal. In general, the widths W1 and W2 are slightly less than the diameter of a corresponding retention clip to facilitate an interference fit between the retention clip and the channels. In some embodiments, the widths W1 and W2 are less than the diameter D1 of the first aperture 130 and less than the diameter D2 of the second aperture 134.

In one exemplary embodiment, the first aperture 130 and the second aperture 134 each have a radius of approximately 9 millimeters while the first channel 138 and the second channel 140 each have a width of approximately 5.8 millimeters. However, it should be understood that other dimensions for the first aperture 130, the second aperture 134, the first channel 138 and the second channel 140 are contemplated.

In the embodiment of the two-stage retention clip housing 120 depicted in FIGS. 1 and 3, the first channel 138 and the second channel 140 do not lie along a common diameter of the first circular aperture (i.e., the smallest angle between the first channel 138 and the second channel 140 is less than 180 degrees). However in other embodiments, the first channel 138 and the second channel 140 may lie along a common diameter of the first circular aperture (i.e., the angle between the first channel 138 and the second channel 140 is 180 degrees).

Referring again to FIG. 1, the trim panel 100 may also include one or more conventional retention clip housings 220.

Unlike the two-stage retention clip housing 120, the conventional retention clip housing 220 does not include a second aperture and a second channel. The first aperture 230 generally defines an installed clip position for receiving a head of a retention clip.

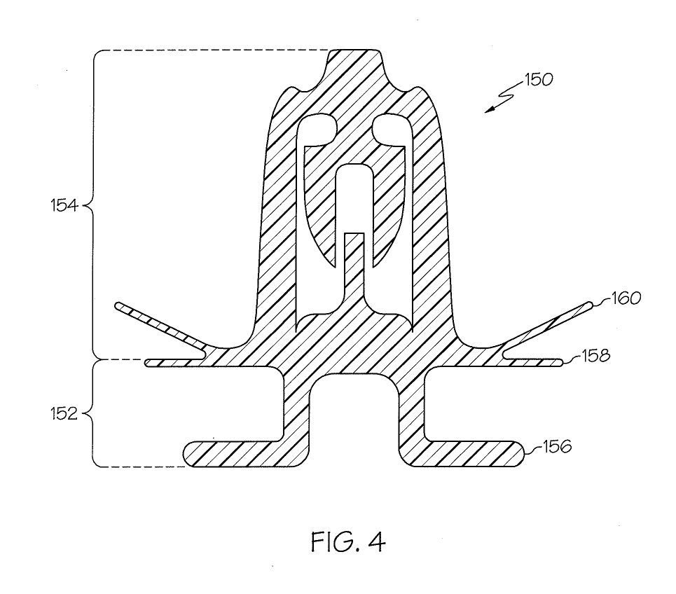

Referring now to FIG. 4, a retention clip 150 includes a head portion 152, a body portion 154, a head flange 156, a body flange 158, and a standoff flange 160. In alternative embodiments, the retention clip may not include a standoff flange. Generally, the head portion 152 attaches to a two-stage retention clip housing 120 and the body portion 154 of the retention clip 150 attaches to a mounting aperture formed in the support structure to which the trim panel is attached. The head portion 152 includes a radially extending head flange 156 at one end of the head portion 152 and a radially extending body flange 158 spaced apart from the head flange 156. A standoff flange 160 is optionally provided adjacent the body flange 158.

As depicted in FIG. 4, the diameter of the head portion 152 of the clip 150 may differ from the diameter of the body portion 154. Furthermore, the diameter of the head flange 156 and the diameter of the body flange 158 are both larger than the diameter of the head portion 152 and body portion 154. In one exemplary embodiment, the diameter of the head portion 152 between the head flange 156 and the body flange 158 is approximately 6.0 millimeters. However, it should be understood that other dimensions for the head portion are contemplated.

The retention clip 150 can be formed from any suitable material such as metal or a polymeric material. Semi-rigid polymeric materials, such as, but not limited to, polyethylene, polypropylene, or polyamides such as nylon are preferred. The retention clip can be formed by conventional extrusion process or injection molding process.

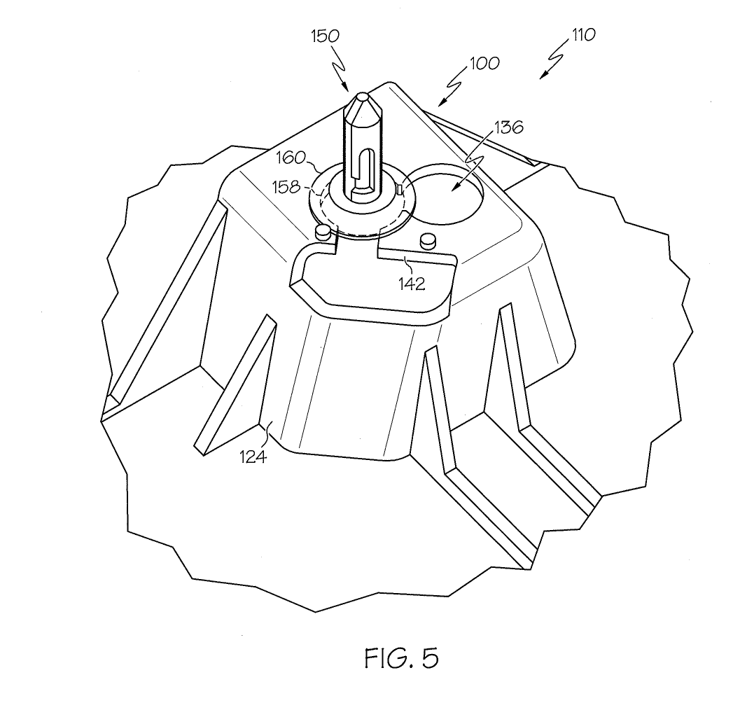

Referring to FIG. 5, the retention clip 150 is shown engaged with the two-stage retention clip housing 120 of the trim panel 100 in a pre-installation clip position 132. The head portion 152 of the clip 150 engages the first aperture 130 of the two-stage retention clip housing 120. To snap fit with the first aperture 130, the head portion 152 is slidably engaged through the first channel 138 and into the first aperture 130. Because the diameter of the head portion is greater than the width of the first channel 138, the head portion 152 of the clip 150 deforms upon installation. When engaged in the first aperture 130, the body flange 158 is positioned above the top surface 122 of the housing 120 and generally covers the first aperture 130. The head flange 156 is positioned under the top surface 122.

Because the head portion 152 is greater in diameter than the width of the second channel 140, the retention clip 150 will not slide into the second channel 140 unless the clip 150 is slightly deformed. Accordingly, if a force great enough to cause deformation of the clip 150 is applied in the direction of the second channel 140, the retention clip 150 will slide through the second channel 140 and into engagement with the second aperture 134 and into the installed clip position 136.

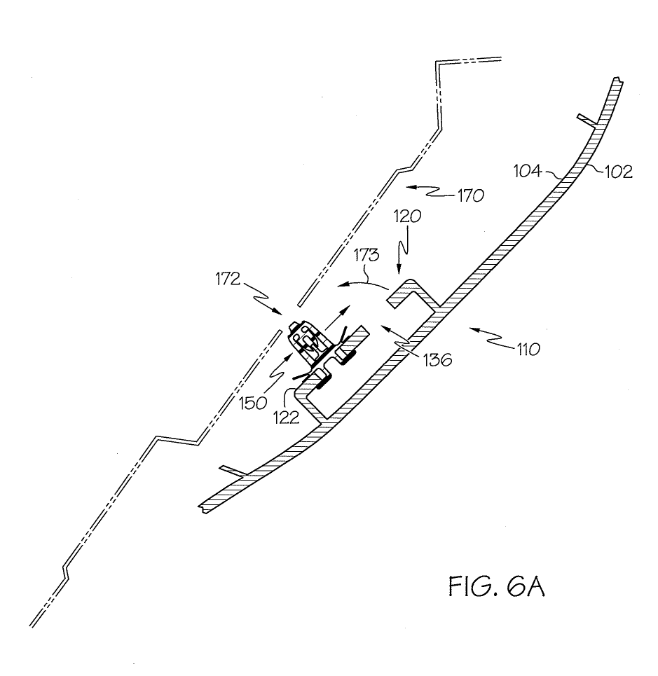

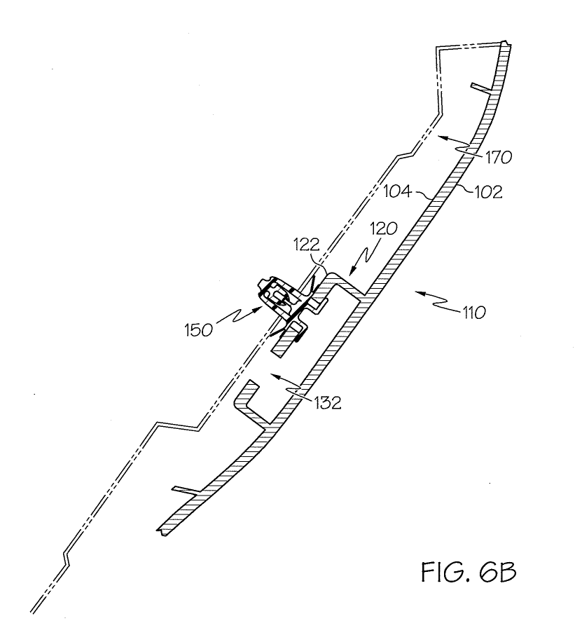

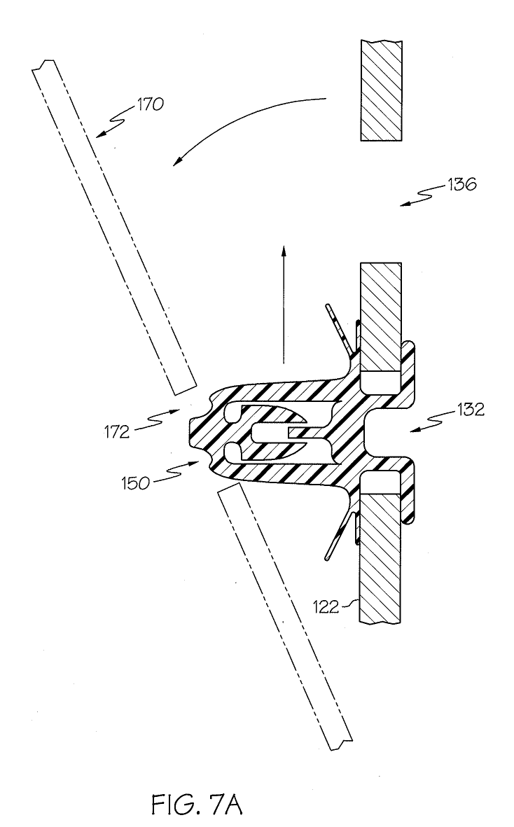

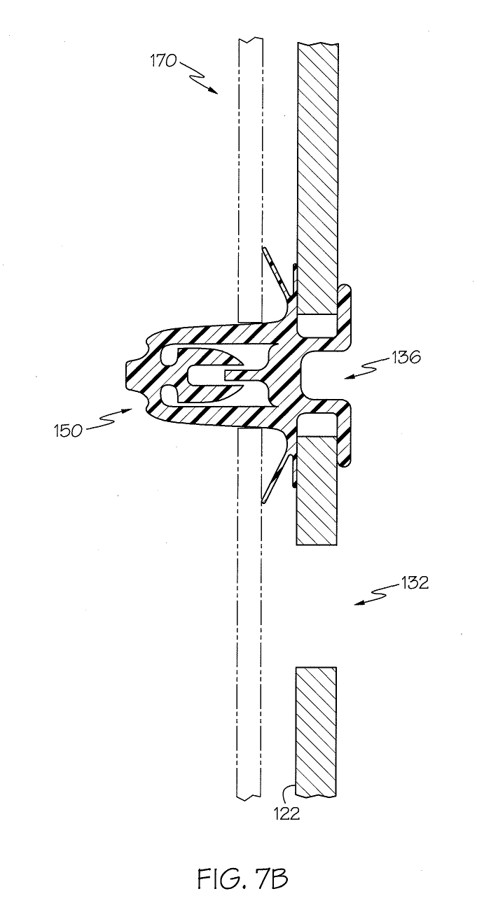

Referring to FIGS. 6A and 6B a trim panel 100 being installed on to a corresponding support structure 170 is schematically depicted. The trim panel 100 is installed on the support structure 170 by inserting the body portion 154 of one or more retention clips 150 into corresponding mounting apertures 172 on the support structure 170. More specifically, the trim panel 100 is first positioned proximate the final installation position such that the attachment guides (not shown) of the trim panel are inserted into slotted openings on the support structure 170 which prevents the lower edge of the trim panel 100 from moving, but allows the rest of the trim panel 100 to rotate with respect to the lower edge of the trim panel, thus defining a locus of rotation. The trim panel 100 may then be rotated about the locus of rotation toward the installed position as indicated by arrow 173 in FIG. 6A. 100411 Referring to FIGS. 6A and 7A, the trim panel 100 is shown in a pre-installed position and the retention clip 150 is shown in profile in a pre-installation clip position 132 within the two-stage retention clip housing 120. The body portion 154 of the retention clip 150 is generally aligned for insertion into a mounting aperture 172 on the support structure 170. The installed clip position 136 is also depicted. A retention clip 150 positioned in the installed clip position 136 would not be properly aligned for insertion into the mounting aperture 172. Once the clip 150 in the pre-installation clip position 132 is aligned and partially inserted into the mounting aperture 172, a force is applied to the trim panel 100 causing the head portion 152 of the retention clip 150 to slide through the second channel 140 and into the second aperture 134 and assume the installed clip position 136, as shown in FIGS. 6B and 7B.

Referring to FIGS. 6B and 7B, the trim panel 100 is shown in an installed position and the retention clip 150 is shown in profile in an installed clip position 136 within the two-stage retention clip housing 120.

It should be understood that a retention clip positioned beyond a threshold distance from the locus of rotation will not require a two-stage retention clip housing while a retention clip positioned within the threshold distance will require a two-stage retention clip housing otherwise the retention clip will not properly seat in the corresponding mounting aperture and/or will be damaged during installation, each of which potentially results in a mis-installation of the trim panel on the mounting structure. This threshold distance is a function of the size of the mounting aperture 172, the length of the body portion 154 of the retention clip 150, and the properties of the material forming the retention clip 150.

It should now be understood that the trim panels with two-stage retention clip housings are beneficial when the trim panels are attached by rotating the trim panel into place on the mounting structure. Particularly, utilizing trim panels with two-stage retention clip housings facilitates rotating the trim panel into the installation position without damaging the retention clip and/or causing a costly mis-installation of the trim panel on the mounting structure. In particular, trim panels with two-stage retention clip housings are most useful for supporting retention clips that are installed near the locus of rotation of the trim panel.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

100461 While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A trim panel for mounting to a support structure of an automotive vehicle by a retention clip, the trim panel comprising:
an inner surface facing an interior of the vehicle and an outer surface facing the support structure; and
a two-stage retention clip housing extending from the outer surface, the two-stage retention clip housing comprising a top surface and at least one sidewall coupling the top surface of the two-stage retention clip housing to the outer surface of the trim panel such that the top surface is spaced apart from the outer surface, the top surface comprising:
a first aperture, the first aperture defining a pre-installation clip position for receiving a head of the retention clip;
a second aperture, the second aperture defining an installed clip position for receiving a head of the retention clip;
a first channel extending from an edge of the top surface to the first aperture, wherein the first channel extends through the edge of the top surface and opens into the first aperture; and
a second channel extending from the first aperture to the second aperture, wherein the second channel opens into the first aperture and the second aperture.

2. The trim panel of claim 1, wherein:
the first aperture has a first diameter; and
the second aperture has a second diameter, wherein a width of the first channel is less than the first diameter and less than the second diameter and a width of the second channel is less than the first diameter and less than the second diameter.

3. The trim panel of claim 1, wherein:
the first aperture has a first diameter; and
the second aperture has a second diameter, wherein the first diameter and the second diameter are equal.

4. The trim panel of claim 1, wherein a smallest angle between the first channel and the second channel is less than 180 degrees.

5. The trim panel of claim 1, further comprising the retention clip positioned in at least one of the pre-installation clip position or the installed clip position.

6. The trim panel of claim 1, wherein the at least one side wall comprises a first sidewall and a second sidewall extending from opposing edges of the top surface.

7. A trim panel assembly for mounting to a support structure of an automotive vehicle, the trim panel assembly comprising:
a retention clip comprising a body portion and a head portion, the head portion comprising a head flange spaced apart from a body flange;
a trim panel comprising an inner surface facing an interior of the vehicle and an outer surface facing the support structure;
a two-stage retention clip housing extending from the outer surface, the two-stage retention clip housing comprising a top surface and at least one sidewall coupling the top surface of the two-stage retention clip housing to the outer surface of the trim panel such that the top surface is spaced apart from the outer surface, the top surface comprising:
a first aperture, the first aperture defining a pre-installation clip position;
a second aperture, the second aperture defining an installed clip position;
a first channel extending from an edge of the top surface to the first aperture, wherein the first channel opens into the first aperture; and
a second channel extending from the first aperture to the second aperture, wherein the second channel opens into the first aperture and the second aperture,
wherein the head portion of the retention clip is slidably engaged with the two-stage retention clip housing in the pre-installation clip position such that the retention clip is slidable from the pre-installation clip position to the installed clip position through the second channel upon attachment of the trim panel assembly to the support structure.

8. The trim panel assembly of claim 7, wherein:
the first aperture has a first diameter;
the second aperture has a second diameter, wherein
a width of the first channel is less than the first diameter and less than the second diameter and a width of the second channel is less than the first diameter and less than the second diameter.

9. The trim panel assembly of claim 7, wherein a smallest angle between the first channel and the second channel is less than 180 degrees.

10. The trim panel assembly of claim 7, wherein:
the first aperture has a first diameter;
the second aperture has a second diameter, wherein the first diameter and the second diameter are equal.

11. The trim panel assembly of claim 7, wherein the at least one side wall comprises a first sidewall and a second sidewall extending from opposing edges of the top surface.

12. The trim panel assembly of claim 7, wherein the body portion of the retention clip comprises a standoff flange axially spaced from the body flange.

13. The trim panel assembly of claim 12, wherein the standoff flange is elastically deformable.

14. A trim panel assembly for mounting to a support structure of an automotive vehicle, the trim panel assembly comprising:
a retention clip comprising a body portion and a head portion;
a trim panel comprising an inner surface facing an interior of the vehicle and an outer surface facing the support structure;
a two-stage retention clip housing extending from the outer surface of the trim panel, the two-stage retention clip housing comprising a top surface with a pre-installation clip position, an installed clip position, and a channel extending between the pre-installation clip position and the installed clip position, wherein the head portion of the retention clip is slidably engaged with the two-stage retention clip housing in the pre-installation clip position such that the retention clip is slidable from the pre-installation clip position to the installed clip position through the channel upon attachment of the trim panel assembly to the support structure.

15. The trim panel assembly of claim 14, wherein:
the pre-installation clip position has a first diameter; and
the installed clip position has a second diameter, wherein a width of the channel is less than the first diameter and less than the second diameter.

16. The trim panel assembly of claim 14, wherein:
the pre-installation clip position has a first diameter; and
the installed clip position has a second diameter, wherein the first diameter and the second diameter are equal.

17. The trim panel assembly of claim 14, wherein the two-stage retention clip housing further comprises at least one sidewall coupling the top surface of the two-stage retention clip housing to the outer surface of the trim panel such that the top surface is spaced apart from the outer surface.

18. The trim panel assembly of claim 14, wherein the head portion of the retention clip comprises a head flange spaced apart from a body flange.

19. The trim panel assembly of claim 18, wherein the body portion of the retention clip comprises a standoff flange axially spaced from the body flange.

20. The trim panel assembly of claim 19, wherein the standoff flange is elastically deformable.
